(19) United States
(12) Patent Application Publication
(10) Pub. No.: US 2008/0041107 A1
(43) Pub. Date: Feb. 21, 2008

(54) Continuous method and system for manufacturing a crystallized glass plate

(75) Inventors: Kuo-Chuan Hsu, Hsin-Pu Town (TW); Chien-Liang Tseng, Zhejiang (CN); Xun-Geng Wang, Zhejiang (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Ta Hsiang Containers Ind. Co., Ltd., Hsin-Pu Town (TW); Huzhou Tahsiang Glass Products Co., Ltd., Zhejiang (CN)

(21) Appl. No.: 11/975,029

(22) Filed: Oct. 16, 2007

Related U.S. Application Data
(62) Division of application No. 10/850,124, filed on May 19, 2004.

(30) Foreign Application Priority Data
Jul. 25, 2003 (JP) 2003-201 941

(51) Int. Cl. C03C 10/00

(52) U.S. Cl. 65/33.9

(57) ABSTRACT

A continuous method for manufacturing crystallized glass plates includes the steps of melting a raw crystallizable glass material to form molten glass, adjusting the molten glass to have a predetermined viscosity, rolling the molten glass to form a belt of crystallizable glass, and passing the belt of crystallizable glass through a crystallization tunnel so as to form a belt of crystallized glass.

### BACKGROUND OF THE INVENTION

1. Field of the Invention

This invention relates to a continuous method and a continuous system for manufacturing a crystallized glass plate from raw crystallizable glass material.

2. Description of the Related Art

Crystallized glass can be used in various applications, such as substrates for high-tech products including color filters and image sensitive substrates, setters for baking electronic components, panels of electromagnetic cookers, optical elements, plates of microwave ovens, fire-resistant window panels, front window panels for petroleum stoves and wood stoves, and building materials. Compared with general glass, crystallized glass has a lower heat expansion coefficient and a higher mechanical strength. Therefore, in recent years, crystallized glass is widely applied to the aforementioned applications. Concerning the crystallized glass, a nuclei-forming component for enhancing the growth of crystal nuclei is required to be added to raw crystallizable glass material so as to permit crystallization of fine crystals. Therefore, in order to manifest the effect of the nuclei-forming component, the crystallized glass is manufactured through a conventional method comprising the steps of melting the raw crystallizable glass material, forming a crystallizable glass plate from the molten raw crystallizable glass material, and crystallizing the crystallizable glass plate.

FIGS. 4 and 5 show an example of the conventional method for manufacturing crystallized glass plates. In these figures, the raw crystallizable glass material is melted in a melting unit 1 to form crystallizable molten glass. The crystallizable molten glass is conveyed to a pre-furnace 2 for adjusting the viscosity of the crystallizable molten glass, and is subsequently conveyed to a pair of forming rollers 3. The crystallizable molten glass is rolled by the pair of forming rollers 3 so as to form a belt of crystallizable glass. The belt of crystallizable glass is subsequently conveyed to an annealing furnace 4, and is annealed in the annealing furnace 4 for reducing stress in the belt of crystallizable glass and for homogenizing the belt of crystallizable glass.

The belt of crystallizable glass is then conveyed to a cutting unit 5, and is cut into segments 6 of crystallizable glass. The segments 6 of crystallizable glass are arranged to form a stack 7 of the segments 6 of crystallizable glass, and the segments 6 of crystallizable glass in the stack 7 are subsequently carried to a crystallization furnace 8 for crystallization so as to form crystallized glass plates 9. The crystallized glass plates 9 are arranged in a stack 10, and the stack 10 of the crystallized glass plates 9 is moved to a secondary processing station for thickness shaving and surface grinding so as to obtain finished products.

It is noted that the aforementioned conventional method is semi-continuous. That is, the segments 6 of crystallizable glass, which have a predetermined size, cut by the cutting unit 5 are required to be moved from the cutting unit 5 to the crystallization furnace 8 for crystallization. As such, it is difficult to achieve mass production and stable quality of the crystallized glass plates 9.

Besides, as described in Japanese Patent Publication No. H09-295819, the conventional method for manufacturing the crystallized glass plates 9 tends to introduce the problem as mentioned herein below due to changes in forces applied to the belt of the crystallizable molten glass. When the raw crystallizable glass material is moved from the melting unit 1 to a support disposed downstream of the pair of forming rollers 3, the belt of crystallizable molten glass is likely to swing due to a drawing force imparted by the conveying rollers. The swing of the belt of crystallizable molten glass can result in instability of the shape of the belt of crystallizable molten glass, unstable conveying, and undesired folding of the belt of crystallizable molten glass.

In addition, since the nuclei-forming component is added to the raw crystallizable glass material, it is known in the art that devitrification is likely to occur when the temperature of the crystallizable molten glass is lowered during movement of the crystallizable molten glass from the pre-furnace 2 to the pair of the forming rollers 3. As the level of devitrification increase with time, processing of the molten glass through the pair of the forming rollers 3 will be harder, and can result in eventual shut down of the rollers 3.

### SUMMARY OF THE INVENTION

Therefore, the object of this invention is to provide a continuous method and a continuous system for manufacturing crystallized glass plates, wherein the operations of melting, forming, crystallizing, and cutting are continuously conducted, so as to solve the above problems as encountered in the prior art.

According to one aspect of this invention, there is provided a continuous method for manufacturing crystallized glass plates. The method includes the steps of: (a) melting a raw crystallizable glass material in a glass-melting furnace to form molten glass; (b) adjusting the molten glass to have a predetermined viscosity; (c) rolling the molten glass to form a belt of crystallizable glass; and (d) passing the belt of crystallizable glass through a crystallization tunnel. The crystallization tunnel includes: a pre-treating zone, wherein the belt of crystallizable glass is controlled at a temperature approximate to a glass transition temperature of the crystallizable glass; a first temperature-raising zone, wherein the belt of crystallizable glass is heated from the glass transition temperature to a nuclei-forming temperature; a nuclei-forming zone, wherein the belt of crystallizable glass is controlled at the nuclei-forming temperature to permit nucleation of the belt of crystallizable glass; a second temperature-raising zone, wherein the belt of crystallizable glass is heated from the nuclei-forming temperature to a crystal-growth temperature; a crystal-growth zone, wherein the belt of crystallizable glass is controlled at the crystal-growth temperature to permit crystallization of the crystallizable glass so as to form a belt of crystallized glass; and an annealing zone, wherein the belt of crystallized glass is gradually cooled so as to reduce stress in the belt of crystallized glass.

According to another aspect of this invention, there is provided a continuous system for forming a crystallized glass plate. The continuous system includes: a glass-melting furnace for melting a raw crystallizable glass material to form molten glass; a viscosity-adjusting unit disposed downstream of the glass-melting furnace for receiving the molten glass from the glass-melting furnace and for adjusting the molten glass to have a predetermined viscosity; a roller unit disposed downstream of the viscosity-adjusting unit for receiving the molten glass from the viscosity-adjusting unit and for rolling the molten glass to form a belt of crystallizable glass; and a crystallization tunnel disposed downstream of the roller unit for receiving the belt of crystallizable glass and for permitting crystallization of the belt of crystallizable glass. The crystallization tunnel includes: a pre-treating zone, which is controlled at a temperature approximate to a glass transition temperature of the crystallizable glass; a first temperature-raising zone, wherein the belt of crystallizable glass is heated from the glass transition temperature to a nuclei-forming temperature; a nuclei-forming zone, wherein the belt of crystallizable glass is controlled at the nuclei-forming temperature to permit nucleation of the belt of crystallizable glass; a second temperature-raising zone, wherein the belt of crystallizable glass is heated from the nuclei-forming temperature to a crystal-growth temperature; a crystal-growth zone, wherein the belt of crystallizable glass is controlled at the crystal-growth temperature to permit crystallization of the crystallizable glass so as to form a belt of crystallized glass; and an annealing zone, wherein the belt of crystallized glass is gradually cooled so as to reduce stress in the belt of crystallized glass.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a schematic view of the preferred embodiment of a continuous system for manufacturing crystallized glass plates according to this invention;

FIG. 2 is a flow chart to illustrate consecutive steps of the preferred embodiment of a continuous method for manufacturing crystallized glass plates according to this invention;

FIG. 3 is a plot to depict a temperature gradient in a crystallization tunnel of the continuous system shown in FIG. 1;

FIG. 4 is a schematic view of a conventional system for manufacturing crystallized glass plates; and

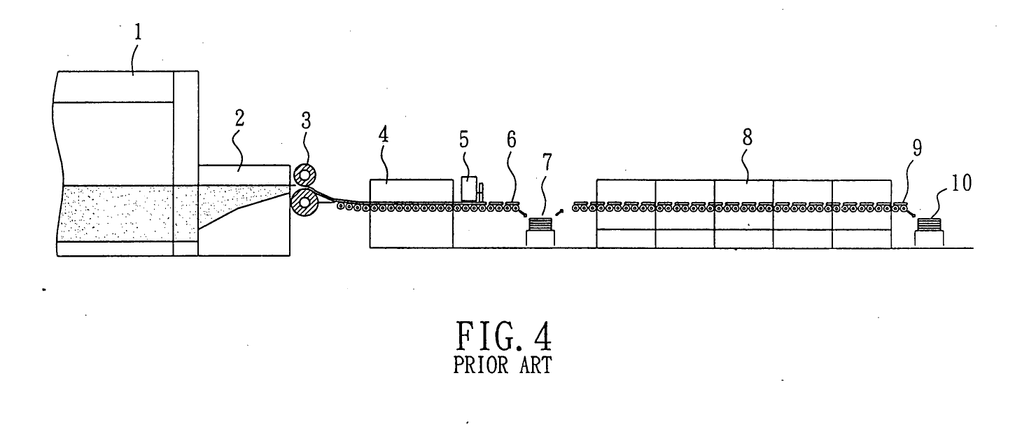

FIG. 5 is a flow chart to illustrate consecutive steps of a conventional method for manufacturing crystallized glass plates.

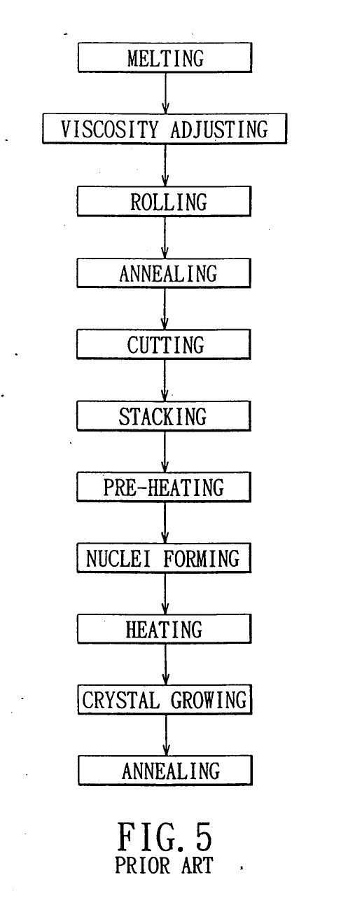

### DETAILED DESCRIPTION OF THE PREFERRED EMBODIMENT(S)

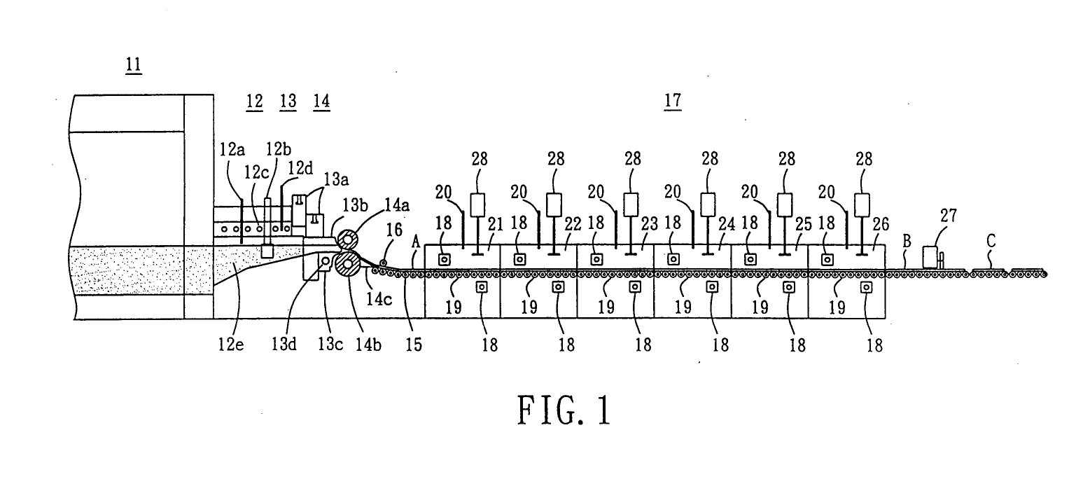

Referring to FIG. 1, numeral 11 denotes a glass-melting furnace for melting raw crystallizable glass material to form molten glass. The glass-melting furnace 11 can be an intermittent furnace having the functions of melting, clarifying and homogenizing the raw crystallizable glass material, or a continuous furnace that combines the functions of melting, clarifying and homogenizing the raw crystallizable glass material.

A viscosity-adjusting unit 12 is disposed downstream of the glass-melting furnace 11, and includes a container 12e for receiving the molten glass from the glass-melting furnace 11. The viscosity-adjusting unit 12 has the function of adjusting the homogeneity, viscosity, and liquid level of the molten glass. The viscosity-adjusting unit 12 is equipped with a liquid-level-controlling unit 12a that monitors the liquid level of the molten glass in the container 12e. The liquid-level-controlling unit 12a transmits an electrical signal corresponding to a change in the liquid level to a feeding unit of the raw crystallizable glass material (not shown) so as to adjust an input amount of the raw crystallizable glass material to the glass-melting furnace 11 and to control the molten glass to have a predetermined liquid level. The viscosity-adjusting unit 12 is also equipped with a stirrer 12b for homogenizing the molten glass. In addition, the viscosity-adjusting unit 12 is equipped with a heating device 12c with a thermocouple 12d for controlling the temperature of the molten glass in the container 12e so as to adjust the molten glass to have the predetermined viscosity.

A devitrification-preventing unit 13 is disposed downstream of the viscosity-adjusting unit 12 for preventing devitrification of the molten glass from occurring. The devitrification-preventing unit 13 includes a temperature-controlling element 13a for maintaining the molten glass at a predetermined temperature during delivery of the molten glass from the viscosity-adjusting unit 12 to a roller unit 14, a guiding brick 13b for smoothly guiding the molten glass from the viscosity-adjusting unit 12 to the roller unit 14, a support 13c for supporting the guiding brick 13b, and a heating element 13d that extends through the support 13c for heating the guiding brick 13b and the support 13c.

The roller unit 14 is disposed downstream of the devitrification-preventing unit 13, receives the molten glass from the devitrification-preventing unit 13, and rolls the molten glass to form a belt of crystallizable glass. The roller unit 14 includes a pair of rollers 14a, 14b and a cooling water tank 14c. The rollers 14a, 14b are made of a material having good heat-resistance, heat impact-resistance, high temperature strength, and heat cracking resistance. The molten glass flows from an outlet of the viscosity-adjusting unit 12 through the devitrification-preventing unit 13 at a predetermined flow rate, and is introduced to a nip between the rollers 14a, 14b of the roller unit 14 in such a manner that the molten glass is rolled to form the belt of crystallizable glass. The belt of crystallizable glass is then cooled by the cooling water tank 14c to keep its shape. The aforesaid flow rate of the molten glass can be controlled through the liquid-level-controlling unit 12a, the stirrer 12b, the heating device 12c and the thermocouple 12d. Moreover, the thickness of the belt of crystallizable glass can be controlled by controlling the flow rate of the molten glass.

An outer conveyer 15 is disposed downstream of the roller unit 14 for conveying the belt of crystallizable glass rolled by the roller unit 14. The outer conveyer 15 is made of a material suitable for conveying the belt of crystallizable glass, and can be in the form of a plurality of rollers or heat-resistant webs.

A pressing unit including one or more pressing rollers 16 is disposed above the conveyer 15. The pressing roller 16 presses the belt of crystallizable glass against the outer conveyer 15 so as to obtain a planar belt (A) of crystallizable glass. The pressing roller 16 is made of a material having good heat-resistance, such as commercially available JIS SUS 410. In addition, the compressing roller 16 is optional and can be omitted, depending on the surface condition of the belt of crystallizable glass rolled by the roller unit 14.

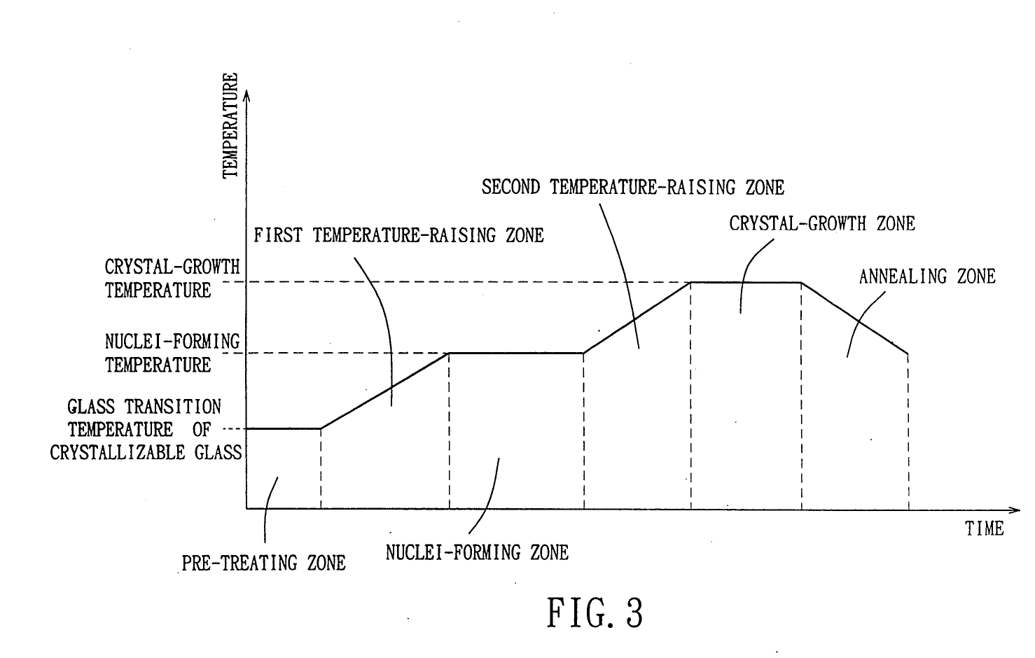

A crystallization tunnel 17 for crystallizing the belt of crystallizable glass is disposed downstream of the conveyer 15. The crystallization tunnel 17 may be a commercially available roller hearth kiln (RHK). The roller hearth kiln (RHK) is essentially equipped with heating elements 18 and a conveyer system 19. The conveyer system 19 is composed of heat-resistant rollers, and is used for continuously conveying the belt of crystallizable glass from the outer conveyer 15 through the crystallization tunnel 17. The heating element 18 may be powered using electricity or gas. With further reference to FIG. 3, the temperature distribution in the crystallization tunnel 17 includes several zones as follows: a pre-treating zone 21, which is controlled at a temperature approximate to a glass transition temperature of the crystallizable glass, the glass transition temperature depending on the composition of the raw material employed; a first temperature-raising zone 22, located downstream of the pre-treating zone 21, wherein the belt of crystallizable glass is heated from the glass transition temperature to a nuclei-forming temperature; a nuclei-forming zone 23, located downstream of the first temperature-raising zone 22, wherein the belt of crystallizable glass is controlled at the nuclei-forming temperature; a second temperature-raising zone 24, located downstream of the nuclei-forming zone 23, wherein the belt of crystallizable glass is heated from the nuclei-forming temperature to a crystal-growth temperature; a crystal-growth zone 25, located downstream of the second temperature-raising zone 24, wherein the belt of crystallizable glass is controlled at the crystal-growth temperature; and an annealing zone 26, located downstream of the crystal-growth zone 25, wherein the belt of crystallized glass is gradually cooled so as to reduce stress in the belt of crystallized glass. FIG. 3 shows the temperature distribution in the crystallization tunnel 17, along with the conveying direction of the belt of crystallizable glass. Each of the aforementioned zones 21 to 26 is equipped with an agitator 28, for keeping a uniform temperature in the respective zone 21 to 26.

As described in the foregoing, the nuclei-forming zone 23 is disposed downstream of the first temperature-raising zone 22. In the nuclei-forming zone 23, the belt of crystallizable glass is controlled at the nuclei-forming temperature to permit nucleation of the belt of crystallizable glass. The nucleation is initiated by the nuclei-forming components, such as TiO₂, ZrO₂, P₂O₅, F₂ and so on, contained in the raw crystallizable glass material. The second temperature-raising zone 24 is disposed downstream of the nuclei-forming zone 23. In the second temperature-raising zone 24, the belt of nucleated crystallizable glass is heated from the nuclei-forming temperature to a crystal-growth temperature, as best shown in FIG. 3.

The crystal-growth zone 25 is disposed downstream of the second temperature-raising zone 24. In the crystal-growth zone 25, the belt of crystallizable glass is controlled at the crystal-growth temperature to permit growth of the crystal and crystallization of the crystallizable glass, thereby forming the belt of crystallized glass. The annealing zone 26 is disposed downstream of the crystal-growth zone 25. In the annealing zone 26, the belt of crystallized glass is gradually cooled so as to reduce stress in the belt of crystallized glass and to ensure uniformity of the belt of crystallized glass.

Each of the zones 21 to 26 of the crystallization tunnel 17 is provided with two of the heating elements 18, which are located on two opposite sides of the conveyer system 19, and a thermocouple 20 for controlling the temperature of the respective one of the zones 21 to 26. The temperature of each of the zones is controlled at a precision error of ±3° C. According to the design of the heating elements 18, crystallization of the belt of crystallizable glass can be easily and accurately conducted. The heating elements 18 can be powered by electricity (SiC heat-generator) or gas, depending on the crystallization temperature.

A cutting unit 27 is disposed downstream of the crystallization tunnel 17 for cutting the belt (B) of crystallized glass. The belt (B) of the crystallized glass is cut by the cutting unit 27 into the crystallized glass plates (C) which have a predetermined size. Thereafter, the crystallized glass plates (C) are moved to a secondary processing factory for subsequent finishing.

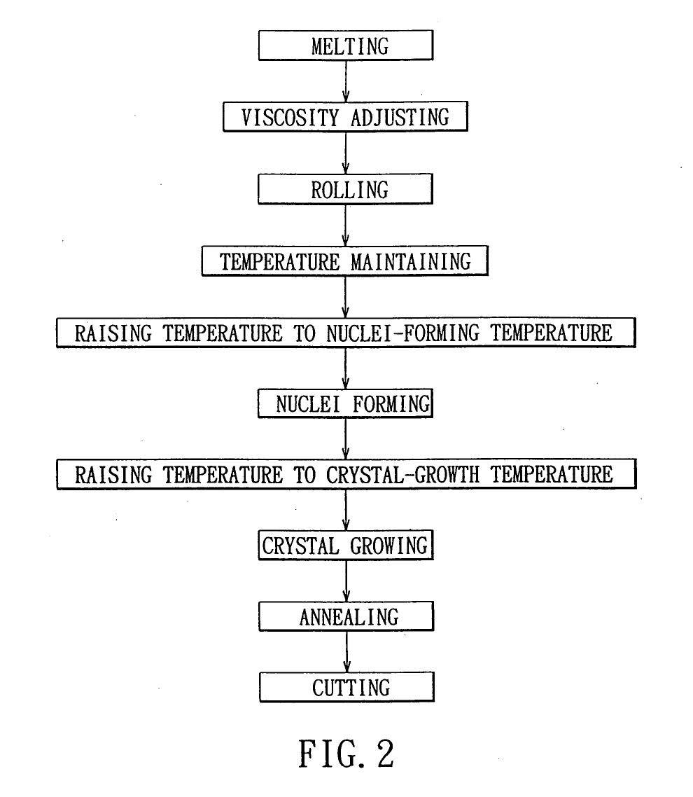

With reference to FIG. 2, since the method of this invention, which includes the processing steps of melting the raw crystallizable glass material, viscosity adjusting, rolling, temperature maintaining, raising temperature to nuclei-forming temperature, nuclei forming, raising temperature to crystal-growth temperature, crystal growing, annealing and cutting, is continuous, mass production of the crystallized glass plates is feasible and stable quality of the crystallized glass plates can be ensured. With the inclusion of the heating device 12c, the thermocouple 12d and the liquid-level-controlling unit 12a in the viscosity-adjusting unit 12, the thickness of the belt of crystallizable glass discharged from the roller unit 14 can be controlled at the desired value.

The transport of the crystallizable glass plates to a separate crystallization furnace for crystallization as required in the conventional method is omitted in the method and system of this invention. Therefore, the manpower required for moving the glass plates can be saved, and the production costs can be dramatically reduced.

On the other hand, since the crystallization tunnel 17 includes the pre-treating zone 21, the first temperature-raising zone 22, the nuclei-forming zone 23, the second temperature-raising zone 24, the crystal-growth zone 25 and the annealing zone 26, the heat treatment necessary for the crystallization of the glass plate can be easily conducted. In addition, since the temperature and the rotating speed of the rollers in the conveyer system of each zone can be controlled independently, the expansion and shrinkage of the belt of glass in the crystallization tunnel 17 can be controlled. Therefore, crystallization of the belt of crystallizable glass formed by the roller unit 14 can be easily and steadily achieved.

In addition, since the belt of crystallizable glass formed in the roller unit 14 is conveyed immediately to the pre-treating zone 21 of the crystallization tunnel 17, which is maintained at a temperature approximate to the glass transition temperature of the crystallizable glass, formation of stress in the belt of crystallizable glass can be avoided during transport of the belt of crystallizable glass from the roller unit 14 to the crystallization tunnel 17. In addition, the annealing step prior to the crystallization step as required in the conventional method can be omitted

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A continuous method for manufacturing crystallized glass plates, comprising the steps of:
(a) melting a raw crystallizable glass material in a glass-melting furnace to form molten glass;
(b) adjusting the molten glass to have a predetermined viscosity;
(c) rolling the molten glass to form a belt of crystallizable glass; and
(d) passing the belt of crystallizable glass through a crystallization tunnel that includes: a pre-treating zone, wherein the belt of crystallizable glass is controlled at a temperature approximate to a glass transition temperature of the crystallizable glass; a first temperature-raising zone, wherein the belt of crystallizable glass is heated from the glass transition temperature to a nuclei-forming temperature; a nuclei-forming zone, wherein the belt of crystallizable glass is controlled at the nuclei-forming temperature to permit nucleation of the belt of crystallizable glass; a second temperature-raising zone, wherein the belt of crystallizable glass is heated from the nuclei-forming temperature to a crystal-growth temperature; a crystal-growth zone, wherein the belt of crystallizable glass is controlled at the crystal-growth temperature to permit crystallization of the crystallizable glass so as to form a belt of crystallized glass; and an annealing zone, wherein the belt of crystallized glass is gradually cooled so as to reduce stress in the belt of crystallized glass.

2. The method of claim 1, further comprising cutting the belt of crystallized glass after step (d) into the crystallized glass plates.

3. The method of claim 1, further comprising stirring the molten glass in step (b), and controlling a liquid level of the molten glass in a container in step (b) by adjusting an input amount of raw crystallizable glass material to the glass-melting furnace.

4-7. (canceled)
